(19) United States
(12) Patent Application Publication
(10) Pub. No.: US 2005/0210601 A1
(43) Pub. Date: Sep. 29, 2005

(54) Soil removal methods and devices employed therein for leather articles

(76) Inventors: Janine Morgens Strang, Deer Park, OH (US); Trace Wendall de Guzman Trajano, Mason, OH (US); Ali Abdelaziz Alwattari, Pointe Claire (CA); Eugene Joseph Pancheri, Montgomery, OH (US); Dean Larry DuVal, Lebanon, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/136,219

(22) Filed: May 24, 2005

Related U.S. Application Data
(62) Division of application No. 10/271,171, filed on Oct. 15, 2002.
(60) Provisional application No. 60/329,663, filed on Oct. 15, 2001.
(60) Provisional application No. 60/329,664, filed on Oct. 15, 2001.

(51) Int. Cl. B29D 1/00

(52) U.S. Cl. 8/141; 8/137

(57) ABSTRACT

Soil removal methods, especially non-immersive soil removal methods, and devices employed in such methods for removing and/or reducing soil present on leather articles are provided.

### RELATED APPLICATIONS

This application is a Divisional Application of co-pending U.S. application Ser. No. 10/271,171, filed on Oct. 15, 2002, which claims priority to U.S. Provisional Application Ser. Nos. 60/329,663 and 60/329,664, both filed on Oct. 15, 2001.

### FIELD OF THE INVENTION

The present invention relates to methods for treating leather articles in need of treatment and compositions and devices employed therein. More particularly, the present invention relates to soil removal methods, especially non-immersive soil removal methods, and compositions and devices employed in such methods for leather articles. Even more particularly, the present invention relates to methods for facilitating the removal of soil from a leather article, especially finished leather articles, without having a deleterious effect on the leather article.

### BACKGROUND OF THE INVENTION

Conventionally, the removal of soils from leather articles has been difficult, especially without having a deleterious effect on the leather article.

Leather articles, particularly leather garments, are often cleaned by processes that remove dirt and grease with an aqueous solution of soap, synthetic detergent, ammonia, or some other cleaning agent, or by treating the leather with an organic solvent. These conventional processes are often immersive processes. None of these techniques is completely satisfactory because each tends to have a deleterious effect on the leather. It is well known that subjecting leather articles to immersive processes has a deleterious effect on leather. Accordingly, there are subsequent remediation steps that leather article service providers use to try to mitigate the damage caused to the leather article during the cleaning processes.

Further, conventional professional dry cleaning techniques for cleaning leather articles are often not satisfactory because of the undesirable effects of solvents on the materials. Both water and PERC are known to strip fat liquors and dyes from leather resulting in unacceptable stiffness and color change. The problem of using either water or PERC are well known and much effort has been devoted to the development of leather treatment systems used in the production of leather that produces water washable or dry cleanable leather. See for example U.S. Pat. No. 5,501,707. The petroleum-based/hydrocarbon-based systems have an undesirable odor that is often difficult to remove. The use of CO2 presents significant engineering difficulty due to the high pressure required to operate it effectively. Further, the conventional leather treating processes often times result in color loss and/or shrinkage.

Accordingly, there is a long felt need for a soil removal method and/or devices employed therein that can remove and/or reduce soil from leather articles, especially finished leather articles such as garments, without having a deleterious effect on the leather articles; as well as a domestic (in-home) method that consumers can use to treat their leather articles without having a deleterious effect on the leather articles.

### SUMMARY OF THE INVENTION

The present invention fulfills the needs identified above by providing a non-immersive method for treating leather articles, especially finished leather articles, even in the home, rather than by a commercial dry cleaner, capable of removing soil from the leather articles without causing a deleterious effect (such as loss of color, loss of suppleness, cracking, fading, abrasion, and the like) to the leather articles.

In one aspect of the present invention, a method for treating a soiled leather article is provided. The method comprises the steps of:

a. non-immersively contacting the soil present on the leather article with a soil removal facilitating agent such that the soil present on the leather article is primed for reduction and/or removal from the leather article; and

b. contacting the soil present on the leather article with a soil removal agent such that the soil is reduced and/or removed from the leather article.

It is desirable that at least one step of contacting the soil present on the leather article with a soil removal agent is a manual step. In other words, it is desirable that the step of contacting the soil present on the leather article with a soil removal agent comprises a user manually rubbing, dabbing, or contacting the soil in any other suitable manner with the soil removal agent. This is distinguished from having a soil removal agent contact the soil while the soiled leather article is present in a container (i.e., an automatic clothes dryer).

In still another embodiment, the present invention provides methods and devices employed therein for removing and/or reducing soil present on a leather article, even a heavily soiled leather article, by rubbing the to be cleaned with a semi-solid article comprising a substantially uniform mixture of a rubber-type material, a liquid plasticizer/solvent for the rubber-type material, and finely divided inorganic filler. Preferred optional ingredients include a pigment to impart a uniform shade, and a thickener to reduce or eliminate cold flow. These materials are compounded so that the article is soft enough so that it can be rubbed repeatedly over the surface to be cleaned, without damaging the surface. It must engage the soiled surface with a light, frictional action, and must not be hard or brittle.

The soil removal facilitating agents and/or soil removal agents may be in any physical form known to those in the art. The agent may be in a two-dimensional form, or a three-dimensional form. They may be releasably associated with a substrate and/or carrier, such as a woven or non-woven substrate or a polymeric substrate.

In still another aspect of the present invention, a method for treating a leather article in need of treatment is provided; the method comprises the step of non-immersively contacting the leather article with a treating composition comprising a non-flammable solvent in the form of a vapor and/or mist such that the leather article is treated.

Accordingly, the present invention provides a method for treating a leather article in a manner that does not cause a deleterious effect on the leather article; a method for treating a soiled leather article to remove and/or reduce the soil present on the leather article; devices (i.e., articles of manufacture) useful in the methods of the present invention; and a leather article treatment kit for treating leather articles, especially soiled leather articles.

These and other objects, features and advantages of the present invention will be recognized by one of ordinary skill in the art from the following description and the appended claims.

All percentages, ratios and proportions herein are on a weight basis unless otherwise indicated. All documents cited herein are hereby incorporated by reference.

### DETAILED DESCRIPTION OF THE INVENTION

Definitions

“Leather article” herein means any article that comprises wholly or partially, a material which is composed of an animal hide or skin that is tanned or treated such that the material is imputrescible. Examples of leather articles are grain leather articles and/or suede leather articles.

“Finished leather article” herein means a leather article which has been processed (i.e., finished) in a way that adds value to a consumer (i.e., a purchaser of the finished leather article). Nonlimiting examples of finished leather articles include, leather garments (i.e., skirts, coats, pants), leather accessories (i.e., belts, gloves, bags, purses, shoes), and leather furniture/upholstery (i.e., leather chairs, leather sofas).

“Deleterious effect” herein means that the physical and/or aesthetic properties of the finished leather article have been negatively impacted. Such deleterious effects may occur in the structure and/or integrity of the finished leather article and/or on the finished surface of the finished leather article. Nonlimiting examples of deleterious effects on finished leather articles include shrinkage, cracking, discoloring, loss of suppleness and/or loss of feel. Once a deleterious effect has occurred to a finished leather article, the finished leather article typically loses value to the owner of the finished leather article because the owner may cease or reduce the use of the finished leather article.

“Non-immersive” herein means that the leather article, particularly the finished leather article is not submerged and/or immersed in a treating liquid or fluid. Non-immersive is distinguished from conventional commercial dry cleaning procedures wherein a finished leather article to be treated is immersed in a dry cleaning fluid.

“Soil” herein means any undesirable substance on a leather article that is desired to be removed. Typically, such soils are water-based soils. “Water-based soils” as used herein means that the soil comprised water at the time it first came in contact with the leather article, or the soil retains a significant portion of water on the leather article. Examples of water-based soils include, but are not limited to, beverages, many food soils, water-soluble dyes, bodily fluids (such as sweat, urine or blood), and outdoor soils (such as grass stains, clay, dust, sand and mud). However, the soils may also comprise hydrophobic soils, such as grease, oils, etc.

“Soil removal facilitating agent” herein means a chemical, physical and/or environmental condition and/or agent that when a soil is contacted with such condition and/or agent, removal of the soil is facilitated (i.e., the soil is made more readily removable such as by making the soil mobile).

“Soil removal agent” herein means a chemical, physical and/or environmental condition and/or agent that when a soil is contacted with such condition and/or agent, the soil is removed and/or reduced.

“Non-flammable solvent” as used herein means an organic solvent that is not flammable under the conditions of the methods of the present invention. The selection of organic solvent will depend upon external factors, such as heat and/or temperature in the treatment method that the organic solvent will be exposed to. Nonlimiting examples of suitable non-flammable solvents include water, cyclic siloxanes, especially D₅, and glycol ethers, especially, methoxy propoxy propanol, ethoxy propoxy propanol, propoxy propoxy propanol, butoxy propoxy propanol, butoxy propanol. The non-flammable solvent may comprise mixtures of suitable non-flammable solvents.

Soil Removal Facilitating Agent

The method of the present invention includes a step of contacting the soil present on the leather article with a soil removal facilitating agent. Specifically, this step comprises one or more of the following:

a. contacting the soil present on the leather article with an aqueous steam;

b. contacting the soil present on the leather article with a gas;

c. contacting the soil present on the leather article with heat;

d. contacting the soil present on the leather article with a solvent; and

e. contacting the soil present on the leather article with a treating composition.

In one embodiment, the aqueous steam is derived from a vapor generator. Nonlimiting examples of a vapor generator include a vaporizing agent releasably associated with a substrate and/or an electrical vapor generator, such as a steamer or a nebulizer.

In another embodiment, the gas contacting the soil typically at a velocity of from about 1 m/s to about 155 m/s, more preferably, about 50 m/s to about 105 m/s even more preferably about 75 m/s to about 105 m/s. In addition to the velocity at which the gas contacts the soil, the gas typically has a gas flow rate of from about 10 l/s to about 70 l/s, more preferably, about 20 l/s to about 42 l/s, even more preferably about 25 l/s to about 30 l/s. Nonlimiting examples of gases suitable for use herein include air, nitrogen, ozone, oxygen, argon, helium, neon, xenon, carbon dioxide and mixtures thereof, more preferably air, nitrogen, ozone, oxygen, argon, helium, and mixtures thereof, even more preferably air, ozone, nitrogen, and mixtures thereof.

The gas used may be of any suitable temperature or humidity. Heat could be supplied to the gas electrically or by passing the gas over a gas flame, such as, is done in a conventional gas dryer.

The step of contacting the soil present on the leather article with heat desirably comprises subjecting the soil present on the leather article with temperature of from about 20° C. to about 95° C., more desirably from about 30° C. to about 85° C.

In one embodiment, the solvent comprises water. In another embodiment, the solvent comprises a silicone moiety. In yet another embodiment, the solvent may comprise water and a silicone moiety.

In still another embodiment, the solvent may be a non-flammable solvent. The nonflammable solvent may be in the form of a vapor and/or a mist, especially wherein the mist comprises one or more non-flammable solvent droplets having an average particle size of from about 0 μm to about 100 μm. Nonlimiting examples of mist sources or mist generators include an aspirator and/or a spray nozzle. Nonlimiting examples of vapor generators include a vaporizing agent releasably associated with a substrate and/or an electrical vapor generator, such as a steamer or a nebulizer. In another embodiment, the non-flammable solvent is not in the form of a vapor or mist.

The treatment compositions can be formulated to be applied to “new” leather articles (i.e. new and/or little worn leather items) for preventative and/or comfort reasons. For example, a consumer may desire to treat such “new” leather articles with a treating composition comprising a non-flammable solvent and optionally, conditioning agents and/or stain repellant agents and/or odor control agents prior to wearing. In another example, a treatment composition containing a UV absorber is applied to prevent fading of the leather article.

In addition, the treating compositions of the present invention can be formulated to be applied to “damaged” leather articles (i.e., brittle and/or cracked and/or aged leather articles) for restoring and/or revitalizing the leather articles. For example, a consumer may desire to treat such “damaged” leather articles with a treating composition comprising a non-flammable solvent and optionally, conditioning agents and/or coloring agents.

The treating composition typically has a pH in the range of from about 3 to about 9, more typically from about 4 to about 8 and even more typically from about 4 to about 7. Techniques for controlling pH at recommended usage levels include the use of buffers, alkalis, acids, etc., and are well known to those skilled in the art.

It is desirable that the treating compositions are essentially free (less than 5% or less than 3% or less than 1% or less than 0.1% or 0%) of bleaching systems, especially types of bleaching agents and/or levels of bleaching agents that would do more damage to the leather than provide benefit to the leather.

In one embodiment, treating composition comprises water and optionally, one or more adjunct ingredients selected from the group consisting of surfactants, perfumes, preservatives, auxiliary cleaning agents, other organic solvents, conditioning agents, UV absorbers, soil release agents, hydrotropes, antioxidants, dyes, perfume, humectants, brighteners, disinfectants, and mixtures thereof.

A more detailed description of the individual components of the treating compositions of the present invention, that is, the organic solvents, surfactants, perfumes, preservatives, and auxiliary cleaning agents can be found in U.S. Pat. No. 5,789,368, which issued on Aug. 4, 1998 to You et al. and in U.S. Pat. No. 5,591,236, which issued on Jan. 7, 1997 to Roetker. The entire disclosure of the You et al. and the Roetker patents are incorporated herein by reference. Additionally, cleaning/refreshment compositions are described in co-pending U.S. patent application Ser. No. 08/789,171, which was filed on Jan. 24, 1997, in the name of Trinh et al. The entire disclosure of the Trinh et al. Application is incorporated herein by reference.

Suitable conditioning agents useful in the methods and compositions of the present invention include, but are not limited to, acrylic syntans and other hydrophobically modified polymers, silicones, siloxanes, fluorocarbons, fatliquors, lecithin, fluoropolymers, sucrose polyesters, oils, waxes, quaternary ammonium salts, betaines and mixtures thereof. Preferably, the conditioning agents are selected from the group consisting of betaines, silicones, siloxanes, and mixtures thereof. More preferably, the conditioning agents are betaines and/or silicones and/or siloxanes. A preferred betaine conditioning agent is Schercotaine IAB® and can be obtained from Scher Chemical. A more detailed description of conditioning agents can be found in WO 01/30955, the entire disclosure of which is incorporated herein by reference.

The surfactant can be nonionic, anionic, ampholytic, amphophilic, zwitterionic, cationic, semi-polar nonionic, and mixtures thereof, nonlimiting examples of which are disclosed in U.S. Pat. Nos. 5,707,950 and 5,576,282. A typical listing of anionic, nonionic, ampholytic and zwitterionic classes, and species of these surfactants, is given in U.S. Pat. No. 3,664,961 issued to Norris on May 23, 1972. Preferred treating compositions contain up to about 5%, by weight of the surfactant. Typical leather treating compositions herein can comprise at least about 80%, by weight, water, preferably at least about 90%, and more preferably at least about 95% water.

Form of Treating Compositions

The treating compositions of the present invention can be in liquid, paste, gel, spray, aerosol, or foam forms and mixtures thereof. Further, the treating compositions of the present invention may be releasably associated with a substrate and/or carrier sheet, or may be contained in a spray dispenser.

In one embodiment, the treating composition is releasably associated with a substrate and/or carrier sheet to create an article of manufacture. “Releasably associated” means that the treating composition is effectively released from the substrate and/or carrier sheet onto a leather article in the form of a vapor and/or a mist as during the step of non-immersively contacting the leather article. This release occurs mainly by volatilization of the treating composition, especially the non-flammable solvent present in the cleaning composition from the substrate and/or carrier sheet, or by a combination of vapor and mist transfer. Bulk liquid transfer of the treating composition to the leather article is desirably minimized.

The substrate and/or carrier sheet can be in any desired form, such as powders, flakes, shreds, and the like. However, it is highly preferred that the substrate be in the form of an integral pad or “sheet” that substantially maintains its structural integrity throughout the process. The substrates and sheets of this invention are sometimes referred to in the literature as “carriers” or “absorbent carrier sheets”; it is understood that all of these labels refer to liquid absorbing materials that can be used to conveniently transport liquids. Such pads or sheets can be prepared, for example, using well-known methods for manufacturing non-woven sheets, paper towels, fibrous bats, cores for bandages, diapers and catamenials, and the like, using materials such as wood pulp, cotton, rayon, polyester fibers, and mixtures thereof. Woven cloth pads may also be used, but are not preferred over non-woven pads due to cost considerations. Integral carrier pads or sheets may also be prepared from natural or synthetic sponges, foams, and the like. Such substrates are described in detail in U.S. Pat. No. 5,789,368, to You et al. which was incorporated herein by reference above. The manufacture of these sheets forms no part of this invention and is already disclosed in the literature. See, for example, U.S. Pat. No. 5,009,747, Viazmensky, et al., Apr. 23, 1991 and U.S. Pat. No. 5,292,581, Viazmensky, et al., Mar. 8, 1994, which are incorporated herein by reference. It is desirable that the substrate and/or carrier sheet is in the form of a cloth and/or woven and/or non-woven towelette.

Commercially available substrates and/or carrier sheets are available from Dexter, Non-Wovens Division, The Dexter Corporation as HYDRASPUN®, especially Grade 10244 and 10444.

In another embodiment, the substrate and/or carrier sheet comprises a differential elongation composite material that comprises at least three layers (i.e., two outer layers and one inner layer), webs or plies, disposed in a layered, face-to-face relationship to form a laminate web. The laminate web is processed by thermal calendaring as described below to provide a plurality of melt bond sites that serve to bond the layers, thereby forming the constituent layers into a unitary web. While the laminate web is disclosed primarily in the context of nonwoven webs and composites, in principle the laminate web can be made out of any web materials that meet the requirements, (e.g., melt properties, extensibility) as disclosed herein. For example, the constituent layers can be films, micro-porous films, apertured films, and the like.

Preferably, the outer layers are nonwovens. Suitable nonwoven materials for the first and second outer layers include, but are not limited to, cellulosics, sponges (i.e., both natural and synthetic), formed films, battings, and combinations thereof. Preferably, the first and second outer layers each comprise materials selected from the group consisting of cellulosic nonwovens, formed films, battings, foams, sponges, reticulated foams, vacuum-formed laminates, scrims, and combinations thereof.

The outer layers may comprise a variety of both natural and synthetic materials. As used herein, “natural” means that the materials are derived from plants, animals, insects or byproducts of plants, animals, and insects. The conventional base starting material is usually a fibrous web comprising any of the common synthetic or natural textile-length fibers, or combinations thereof.

The inner layer is an absorbent layer, such as a cellulosic material, such as paper, tissue, paper towel, paper napkins; a metallic material, such as a metallic foil; a woven or knit material, such as cotton or rayon blends; or a thermoset material, such as a polyester or aromatic polyamide film.

Nonlimiting examples of natural materials useful in the layers of the laminate web include, but are not limited to, silk fibers, keratin fibers and cellulosic fibers. Nonlimiting examples of keratin fibers include those selected from the group consisting of wool fibers, camel hair fibers, and the like. Nonlimiting examples of cellulosic fibers include those selected from the group consisting of wood pulp fibers, cotton fibers, hemp fibers, jute fibers, flax fibers, and combinations thereof. Cellulosic fiber materials are preferred in the present invention.

Nonlimiting examples of synthetic materials useful in the layers of the laminate web include those selected from the group consisting of acetate fibers, acrylic fibers, cellulose ester fibers, modacrylic fibers, polyamide fibers, polyester fibers, polyolefin fibers, polyvinyl alcohol fibers, rayon fibers, polyethylene foam, polyurethane foam, and combinations thereof. Examples of suitable synthetic materials include acrylics such as acrilan, creslan, and the acrylonitrile-based fiber, orlon; cellulose ester fibers such as cellulose acetate, arnel, and acele; polyamides such as nylons (e.g., nylon 6, nylon 66, nylon 610, and the like); polyesters such as fortrel, kodel, and the polyethylene terephthalate fiber, polybutylene terephalate fiber, dacron; polyolefins such as polypropylene, polyethylene; polyvinyl acetate fibers; polyurethane foams and combinations thereof. These and other suitable fibers and the nonwovens prepared therefrom are generally described in Riedel, “Nonwoven Bonding Methods and Materials,” Nonwoven World (1987); The Encyclopedia Americana, vol. 11, pp. 147-153, and vol. 26, pp. 566-581 (1984); U.S. Pat. No. 4,891,227, to Thaman et al., issued Jan. 2, 1990; and U.S. Pat. No. 4,891,228, each of which is incorporated by reference herein in its entirety.

Nonwovens made from natural materials consist of webs or sheets most commonly formed on a fine wire screen from a liquid suspension of the fibers. See C. A. Hampel et al., The Encyclopedia of Chemistry, third edition, 1973, pp. 793-795 (1973); The Encyclopedia Americana, vol. 21, pp. 376-383 (1984); and G. A. Smook, Handbook of Pulp and Paper Technologies, Technical Association for the Pulp and Paper Industry (1986); which are incorporated by reference herein in their entirety.

Natural material nonwovens useful in the laminate web of present invention may be obtained from a wide variety of commercial sources. Nonlimiting examples of suitable commercially available paper layers useful herein include Airtex®, an embossed airlaid cellulosic layer having a base weight of about 71 gsy, available from James River, Green Bay, Wis.; and Walkisoft®, an embossed airlaid cellulosic having a base weight of about 75 gsy, available from Walkisoft U.S.A., Mount Holly, N.C.

Additional suitable nonwoven materials include, but are not limited to, those disclosed in U.S. Pat. No. 4,447,294, issued to Osborn on May 8, 1984; U.S. Pat. No. 4,603,176 issued to Bjorkquist on Jul. 29, 1986; U.S. Pat. No. 4,981,557 issued to Bjorkquist on Jan. 1, 1991; U.S. Pat. No. 5,085,736 issued to Bjorkquist on Feb. 4, 1992; U.S. Pat. No. 5,138,002 issued to Bjorkquist on Aug. 8, 1992; U.S. Pat. No. 5,262,007 issued to Phan et al. on Nov. 16, 1993; U.S. Pat. No. 5,264,082, issued to Phan et al. on Nov. 23, 1993; U.S. Pat. No. 4,637,859 issued to Trokhan on Jan. 20, 1987; U.S. Pat. No. 4,529,480 issued to Trokhan on Jul. 16, 1985; U.S. Pat. No. 4,687,153 issued to McNeil on Aug. 18, 1987; U.S. Pat. No. 5,223,096 issued to Phan et al. on Jun. 29, 1993 and U.S. Pat. No. 5,679,222, issued to Rasch et al. on Oct. 21, 1997; U.S. Pat. No. 5,628,097 issued to Benson et al. on May 13, 1997; U.S. Pat. Nos. 5,916,661 and 5,658,639, both issued to Benson et al. on Jun. 29, 1999; each of which is incorporated by reference herein in its entirety.

In another embodiment, the treating compositions of the present invention are incorporated into a spray dispenser to create an article of manufacture that can facilitate treatment of leather with said treating compositions. The spray dispenser may comprise manually activated and non-manual powered (operated) spray means and a container containing the treating composition. The articles of manufacture preferably are in association with instructions for use to ensure that the consumer applies sufficient amounts of the treating composition to the leather article to be treated.

The spray-treatment compositions herein are typically packaged in spray dispensers. The spray dispensers can be any of the manually activated means for producing a spray of liquid droplets as is known in the art, e.g. trigger-type, pump-type, non-aerosol self-pressurized, and aerosol-type spray means. Typical compositions to be dispensed from a sprayer contain a level of benefit agent of from about 0.01% to about 20%, preferably from about 0.1% to about 15%, more preferably from about 0.5% to about 10%, by weight of the usage composition. Preferably, the mist comprises one or more water droplets having an average particle size of from about 0 μm to about 100 μm such that the leather article is treated.

The spray dispenser can be an aerosol dispenser. Said aerosol dispenser comprises a container which can be constructed of any of the conventional materials employed in fabricating aerosol containers. The dispenser must be capable of withstanding internal pressure in the range of from about 20 to about 110 p.s.i.g., more preferably from about 20 to about 70 p.s.i.g. The one important requirement concerning the dispenser is that it be provided with a valve member which will permit the treating compositions of the present invention contained in the dispenser to be dispensed in the form of a spray of very fine, or finely divided, particles or droplets. A more complete description of commercially available suitable aerosol spray dispensers appears in U.S. Pat. No. 3,436,772, Stebbins, issued Apr. 8, 1969; and U.S. Pat. No. 3,600,325, Kaufman et al., issued Aug. 17, 1971.

Preferably the spray dispenser is a self-pressurized non-aerosol container having a convoluted liner and an elastomeric sleeve. A more complete description of suitable self-pressurized spray dispensers can be found in U.S. Pat. No. 5,111,971, Winer, issued May 12, 1992; and U.S. Pat. No. 5,232,126, Winer, issued Aug. 3, 1993. Another type of suitable aerosol spray dispenser is one wherein a barrier separates the wrinkle reducing composition from the propellant (preferably compressed air or nitrogen), as is disclosed in U.S. Pat. No. 4,260,110, issued Apr. 7, 1981, incorporated herein by reference. Such a dispenser is available from EP Spray Systems, East Hanover, N.J.

More preferably, the spray dispenser is a non-aerosol, manually activated, pump-spray dispenser. A more complete disclosure of commercially available suitable dispensing devices appears in: U.S. Pat. No. 4,895,279, Schultz, issued Jan. 23, 1990; U.S. Pat. No. 4,735,347, Schultz et al., issued Apr. 5, 1988; and U.S. Pat. No. 4,274,560, Carter, issued Jun. 23, 1981.

Most preferably, the spray dispenser is a manually activated trigger-spray dispenser. A more complete disclosure of commercially available suitable dispensing devices appears in U.S. Pat. No. 4,082,223, Nozawa, issued Apr. 4, 1978; U.S. Pat. No. 4,161,288, McKinney, issued Jul. 7, 1985; U.S. Pat. No. 4,434,917, Saito et al., issued Mar. 6, 1984; and U.S. Pat. No. 4,819,835, Tasaki, issued Apr. 11, 1989; U.S. Pat. No. 5,303,867, Peterson, issued Apr. 19, 1994.

Broad arrays of trigger sprayers or finger pump sprayers are suitable for use with the compositions of this invention. These are readily available from suppliers such as Calmar, Inc., City of Industry, Calif.; CSI (Continental Sprayers, Inc.), St. Peters, Mo.; Berry Plastics Corp., Evansville, Ind.—a distributor of Guala® sprayers; or Seaquest Dispensing, Cary, Ill.

The preferred trigger sprayers are the blue inserted Guala® sprayer, available from Berry Plastics Corp., the Calmar TS800-1A® sprayers, available from Calmar Inc., or the CSI T7500® available from Continental Sprayers Inc., because of the fine uniform spray characteristics, spray volume and pattern size. Any suitable bottle or container can be used with the trigger sprayer, the preferred bottle is a 17 fl-oz. bottle (about 500 ml) of good ergonomics similar in shape to the Cinch® bottle. It can be made of any materials such as high density polyethylene, polypropylene, polyvinyl chloride, polystyrene, polyethylene terephthalate, glass or any other material that forms bottles. Preferably, it is made of high density polyethylene or polyethylene terephthalate.

For smaller four fl-oz size (about 118 ml), a finger pump can be used with canister or cylindrical bottle. The preferred pump for this application is the cylindrical Euromist II® from Seaquest Dispensing.

Container

The container may be in any physical form. The container may be a bag, a rigid container, a flexible container, especially a collapsible flexible container, an automatic clothes dryer, and other heating devices suitable for receiving and/or treating a leather article in need of treatment. The container typically has an opening to access the leather articles. It is desirable that the container is a bag and/or flexible container and/or an automatic clothes dryer. It is more desirable that the container is a bag, especially a reusable bag, and/or an automatic clothes dryer.

In one embodiment, the container is a bag, especially a venting bag. Nonlimiting examples of such bags are described in U.S. Pat. No. 5,789,368, to You et al.. Additional disclosure of the bags, methods of using and making the bags, and materials of construction for the bags that are preferred for use in this invention can be found in U.S. Pat. No. 5,762,648, which issued on Jun. 9, 1998, to Yeazell, and in U.S. Pat. No. 5,681,355, which issued on Oct. 28, 1997, to Davis et al.

Soil Removal Agent

The method of the present invention optionally includes a step of contacting the soil present on the leather article with a soil removal agent. Specifically, this step comprises one or more of the following:

a. contacting the soil present on the leather article with a solid article;

b. contacting the soil present on the leather article with a semi-solid article;

c. contacting the soil present on the leather article with a liquid;

d. contacting the soil present on the leather article with a textured surface; and

e. contacting the soil present on the leather article with an abrasive agent.

In one embodiment, the solid article comprises rubber and/or a rubber-type material. In another embodiment, the solid article comprises a monomer selected from the group consisting of: butadiene, styrene, isobutylene, isoprene, ethylene, propylene, acrylonitrile, polyisoprene, butyl, polyisobutylene, neoprene, nitrile and mixtures thereof. In yet another embodiment, the solid article comprises an abrasive agent.

In one embodiment, the semi-solid article comprises polyvinyl alcohol, polyacrylates and mixtures thereof. In another embodiment, the semi-solid article comprises a substrate upon which a tacky material is carried. A nonlimiting example of a suitably tacky material is hydrogel.

The liquid typically comprises a solvent. The solvent desirably comprises a hydrophobic solvent. The hydrophobic solvent desirably comprises a silicone moiety. In a desired embodiment, liquid is releasably associated with a substrate. For example, the liquid is releasably absorbed to the substrate such that upon contacting the soil present on the leather article with the substrate, the liquid contacts the soil.

The use of a texture surface with or without an attached implement as a means to scrub and loosen soil because the textured surface can have more mechanical contact and intimacy to scrape soils from a stain. The reduction to practice is either embossing or engraving or mechanically forming texture onto a plastic sheet, a rubber material, a nonwoven, or a three dimensional object such as a bottle cap or plastic stylus such that surface roughness is created.

Any of these materials can be attached to a handle or wand with the textured material at the end or along the length of the wand. This allows the texture to be moved into contact at different positions and angles and pressures with the soil. For example, create a texture on a hard high density polyethylene film via mechanical formation or embossing, then adhere this film by wrapping around or gluing to a flat piece of wood or plastic. This creates a simple implement that can be rubbed. Important added embodiments are that textured surface can be used in combination with cleaning fluids that have be pretreated on fabric or simply deposited on the texture prior to rubbing. Another embodiment is to place rubber particles or pieces into the textured surface such that both rubbing roughness and ribbed effect of the texture and the erasing of rubber can be combined together to maximize surface cleaning.

In one embodiment, the soil removal agent comprises a pliable, relatively soft, solid and cohesive article for cleaning a spotted or soiled surface of grain leather or suede leather, and that is formed from a uniform mixture of from about 20% to about 60% by weight of the article of a rubber-type material formed from a homopolymer or copolymer of a monomer selected from the group consisting of monomers having at least four carbon atoms and two conjugated double bonds, and isobutylene, from 10% to 50% by weight of the article of a liquid plasticizer/solvent for the rubber-type material, said plasticizer/solvent having a boiling point at atmospheric pressure no lower than about 120.degree. C., and rendering the article soft and flexible for use, and from 10% to no more than 50% by weight of the article of finely divided inorganic particulate filler, said mixture being compounded so that the article is yielding on contact with the surface to be cleaned to avoid damage to the surface while permitting frictional engagement of the article therewith.

In another embodiment, the soil removal agent comprises a pliable, relatively soft, solid and cohesive article for cleaning a soiled surface of grain leather or suede by rubbing it over the surface as needed, as often as needed, said article being formed from a rubber-type material formed from a homopolymer or copolymer of a monomer selected from the group consisting of monomers having at least four carbon atoms and two conjugated double bonds, and isobutylene, and a plasticizer/solvent for this material, said plasticizer/solvent having a boiling point at atmospheric pressure, no lower than about 120° C., in the relative proportions to each other from 20 to 60 parts by weight of rubber-type material to from 40 to 80 parts by weight of the liquid plasticizer/solvent, a finely divided inorganic particulate filler, and a sufficient amount of a thickener so that the article is essentially free from cold flow, all in a substantially uniform mixture, said mixture being formulated so that the article is sufficiently yielding on contact with the surface to be cleaned to avoid damage to that surface while permitting frictional passage thereover for cleaning.

The precise formulation and/or form of the soil removal agent selected for use will depend at least in part upon the type of packaging that is to be used. If the soil removal agent is to be sold in a case like a lipstick, the case may be designed to offer support to the soil removal agent, and it may be compounded to be softer than otherwise. If the soil removal agent is to be sold in a package that is not supportive, then it must be compounded to be firm and self-supporting.

In one embodiment, a soil removal agent prepared for use in accordance with the present invention is composed of a rubber or rubber-type compound, a particulate filler, and a liquid material that acts both as a plasticizer and a liquid plasticizer/solvent. These components are formed into a substantially uniform mixture in the proportions, by weight of the mixture, of 20% to 60% of the rubber, 10% to 50% of the filler, and 10% to 50% of the liquid plasticizer/solvent. The soil removal agent should be prepared so that it is pliable, relatively soft, yet solid and cohesive.

The proportions and the ingredients should be selected so that the soil removal agent is soft enough not to damage the surface of the leather article that is being cleaned, when it is rubbed over the soiled area. The rubbing action absorbs the dirt, grease and other soiling elements from the leather article, and is effective for cleaning, particularly for removing greasy spots and perspiration marks. The soil removal agent should be compounded so that while flexible, pliable and soft, it is cohesive enough so that it does not leave an excessive amount of debris, and is economical in use.

The rubber-type materials that are useful in making a soil removal agent in accordance with the present invention are preferably homopolymers or copolymers of monomers having at least four carbon atoms and two conjugated double bonds. Examples of such monomers are isoprene, butadiene, and chloroprene. These may be polymerized singly, or together with other olefinic materials such as isobutene, and the like.

Many types of rubber are satisfactory for use in the invention. Among others, the copolymers of butadiene and styrene have been generally found to be satisfactory. Copolymers of butadiene and acrylonitrile are also useful.

Vistanex, a rubbery material obtained by the polymerization of isobutylene in the presence of a catalyst, is a satisfactory rubber. Unlike natural rubber and many of the synthetics, it is a completely saturated polymer, but is a preferred material for the present invention. Another preferred material is butyl rubber, that is, a copolymer of isobutylene with a small amount of a diolefin such as isoprene. Natural rubber is also useful.

The rubber, when present, is ordinarily present in the soil removal agent in an amount not less than 20% by weight of the article, but not more than 60% by weight of the article. When less than 20% by weight of rubber or rubber-type material is employed, the article tends to be brittle and often does not exhibit satisfactory cleaning power. Articles containing more than 60% of rubber-type material are difficult to handle because they are too resilient, and often exhibit too much friction when rubbed against the surface of a leather article.

The preferred butyl rubbers and polyisobutylenes exhibit excellent characteristics with respect to picking up and absorbing dirt, oil, and grease. Soil removal agents prepared from these rubbers also have the ability to absorb ink spots such as those made by a ball point pen.

A particularly preferred rubber-type material is Vistanex L-100, a product of Exxon Chemical Company, which is a high molecular weight polyisobutylene (Staudinger molecular weight, 81,000-99,000). The high molecular weight polymer was selected because in general the molecular weight of the rubber-type material, the less the cold flow of the finished article.

Another advantage is that generally, the higher the molecular weight, the less the cleaning article product tends to be sticky. Another preferred material is Vistanex MM-L-100, a somewhat similar polyisobutylene. The butyl rubber identified by its producer, Exxon, as Enjay butyl rubber No. 065, is another preferred material. Natural rubber may be used, but generally does not make as uniform a product as the synthetic polymers such as Vistanex L-100. Chlorobutyl rubber of the same molecular weight range as Vistanex L-100 is also a very useful material, but offers no advantage over Vistanex L-100.

The primary purpose of the liquid plasticizer/solvent material is to render the rubber soft enough and flexible enough so that it can be safely, easily, and efficiently used for soil removal as intended. The material selected should have a boiling point, at atmospheric pressure, no lower than about 120° C., so as to minimize evaporation losses during storage.

The most suitable materials are the esters of aliphatic alcohols containing one through ten carbon atoms per molecule, with acids such as sebacic, phthalic, azelaic, and adipic acids. Thus, the preferred monomeric ester plasticizers are dioctyl adipate, di-isodecyl adipate, dioctyl sebacate, di(2-ethyl hexyl) azelate, dicyclohexyl phthalate, and the like. Other suitable materials are solvents such as xylene, tetralin, 1,2,4-trichlorobenzene and dimethylacetamide.

While dioctyl adipate is the preferred material, particularly for use with Vistanex L-100 polyisobutylene, low molecular weight polybutene, such as the Amoco product Polybutene L-14, is also useful, imparting the same pliability with slightly more tack. Paraffin oils also impart the same pliability but more tack than the low molecular weight polybutenes. When the paraffin oils are used, generally the higher the viscosity of the oil, the stiffer is the end product.

The amount of liquid plasticizer/solvent, when present, in the soil removal agent should be no lower than about 10%, and generally no higher than about 50% by weight. Soil removal agents that contain less than 10% of the liquid plasticizer/solvent generally are too stiff for easy handling, and they do not have adequate cleaning power. Soil removal agents that contain more than about 50% of the liquid plasticizer/solvent are generally too soft to be practical.

Commercially available soil removal agents, specifically erasers, are available from Kiwi and/or Griffin.

Methods

The steps of contacting the soil present on the leather article with a soil removal facilitating agent and contacting the soil present on the leather article with a soil removal agent may occur contemporaneously.

Alternatively, the step of contacting the soil present on the leather article with a soil removal facilitating agent may occur prior to and/or after the step of contacting the soil present on the leather article with a soil removal agent.

In yet another embodiment, the step of contacting the soil present on the leather article with a soil removal facilitating agent may occur after a first step of contacting the soil present on the leather article with a soil removal agent, but before a second step of contacting the soil present on the leather article with a soil removal agent.

The step of contacting the soil present on the leather article may and desirably does occur within a container, such as a bag, and/or a rigid or flexible container. It is desirable that the container is reusable, and further that the container wholly or partially is made of a fabric material.

In another embodiment, the method of the present invention may comprise the step of non-immersively contacting the leather article in need of treatment with a treating composition comprising a non-flammable solvent in the form of a vapor and/or a mist may occur in a container and/or in an “open” environment, such as in a laundry room or other part of a house, or in a commercial dry cleaning shop. However, it is desirable that the method of the present invention includes at least one step that occurs in a container that substantially encloses the leather articles being treated. By “substantially encloses”, it is meant that the leather articles are enclosed in the container, but that the container can, and preferably will, permit venting.

Accordingly, if the leather article is non-immersively contacted by the treating composition in an “open” environment, then it is desirable that the treated leather article be subsequently placed in a container to complete the treatment process. Typically, the leather article would be subjected to a temperature above ambient temperature within the container. Further, the leather article is desirably tumbled within the container.

On the other hand, if the leather article is non-immersively contacted by the treating composition within a container, then there is no need to subsequently treat the leather article in an “open” environment, though one could do so if desired.

Any or all of the steps of the method in accordance with the present invention may be repeated more than once as necessary for removing and/or reducing the soil on the leather article.

While the invention has been disclosed herein by reference to the details of several embodiments thereof, it is to be understood that this disclosure is intended in an illustrative sense rather than in a limiting sense, as it is contemplated that modifications in the formulation of the components and in their proportions will readily occur to those skilled in the art, within the spirit of the invention and within the scope of the appended claims.

The following Examples further illustrate the invention, but are not intended to be limiting thereof.

### EXAMPLE I

### Leather Treating Composition

Leather treating composition for use in accordance with the present invention is prepared as follows:

| Ingredient | wt (%) |
|---|---|
| Schercotaine IAB ® | 3.0% |
| Perfume | 0.10% |
| Proxel GXL ® | 0.015% |
| Uniquat 2250 ® | 0.10% |
| BPP (Butoxy Propoxy Propanol)* | 0.50% |
| Deionized Water | Balance |

*BPP is a solvent available from Dow Chemical

Schercotaine IAB is a betaine conditioning agent available from Scher Chemical
Uniquat 2250 is a preservative agent available from Lonza

### EXAMPLE II

### Cleaning and Refreshing Composition

Leather treating composition for use in accordance with the present invention is prepared as follows:

| Ingredient | % (wt.) |
|---|---|
| Emulsifier (TWEEN 20)* | 0.5 |
| Perfume | 0.5 |
| KATHON ® | 0.0003 |
| Sodium Benzoate | 0.1 |
| Water | Balance |

*Polyoxyethylene (20) sorbitan monolaurate available from ICI Surfactants.

### EXAMPLE III

### Leather Treating Compositions

In an alternative embodiment, a leather treating composition for use in accordance with the present invention is prepared as follows:

| Ingredient | % (wt.) | Range (% wt.) |
|---|---|---|
| Water | 99.0 | 95.1-99.9 |
| Perfume | 0.5 | 0.05-1.5 |
| Surfactant | 0.5 | 0.05-2.0 |
| Ethanol or Isopropanol | 0 | Optional to 4% |
| Solvent (e.g. BPP) | 0 | Optional to 4% |

pH range from about 6 to about 8.

### EXAMPLE IV

A kit in accordance with the present invention comprises the following:
a. a leather article cleaning/refreshment composition and/or one or more carrier sheets containing a leather article cleaning/refreshment; and
b. optionally, one or more containment bags, woven or non-woven, plastic or fabric, preferably fabric, venting or non-venting, preferably venting; and
c. instructions for using a. to treat a leather article in need of treatment.

1. A method for treating a soiled leather article comprising the steps of:
(i) non-immersively contacting the soil present on the leather article with a soil removal facilitating agent; and
(ii) optionally, contacting the soil present on the leather article with a soil removal agent whereby the soil is reduced and/or removed from the leather article.

2. The method according to claim 1 wherein step (i) comprises one or more of the following:
a. contacting the soil present on the leather article with an aqueous steam;
b. contacting the soil present on the leather article with a gas;
c. contacting the soil present on the leather article with heat;
d. contacting the soil present on the leather article with a solvent; and
e. contacting the soil present on the leather article with a treating composition.

3. The method according to claim 2 wherein the step of contacting the soil present on the leather article with heat comprises subjecting the soil present on the leather article with temperature of from about 20° C. about 95° C.

4. The method according to claim 2 wherein the step of contacting the soil present on the leather article with a gas comprises contacting the soil present on the leather article with a gas having a velocity of from about 1 m/s to about 155 m/s.

5. The method according to claim 2 wherein the solvent comprises water.

6. The method according to claim 2 wherein the solvent comprises a silicone moiety.

7. The method according to claim 2 wherein the treating composition comprises a non-flammable solvent.

8. The method according to claim 2 wherein the treating composition is released from a substrate.

9. The method according to claim 1 wherein the step of contacting the leather article occurs within a container.

10. The method according to claim 9 wherein the container comprises an automatic clothes dryer.

11. The method according to claim 9 wherein the container comprises a bag.

12. The method according to claim 11 wherein the bag is contained within an automatic clothes dryer.

13. The method according to claim 1 wherein the leather article is a finished leather article.

14. The method according to claim 1 wherein the treating composition further comprises an agent selected from the group consisting of: surfactants, cyclic siloxanes, propylene glycol, ethoxylated propanol solvents, ethoxylated ethanol solvents, conditioning agents, UV absorbing agents, perfumes, rheology modifiers, silicones, waterproofing and/or stain repellant agents and mixtures thereof.

15. The method according to claim 1 wherein the step of contacting the soil present on the leather article with a treating composition comprises delivering the treating composition from a spray dispenser to the soil present on the leather article.

16. The method according to claim 1 wherein Step (ii) comprises one or more of the following:
a. contacting the soil present on the leather article with a solid article;
b. contacting the soil present on the leather article with a semi-solid article;
c. contacting the soil present on the leather article with a liquid releasably associated with a substrate;
d. contacting the soil present on the leather article with a textured surface; and
e. contacting the soil present on the leather article with an abrasive agent.

17. The method according to claim 16 wherein the solid article comprises rubber.

18. The method according to claim 17 wherein the rubber comprises a monomer selected from the group consisting of: butadiene, styrene, isobutylene, isoprene, ethylene, propylene, acrylonitrile, polyisoprene, butyl, polyisobutylene, neoprene, nitrile and mixtures thereof.

19. The method according to claim 16 wherein the solid article comprises an abrasive agent.

20. The method according to claim 16 wherein the semi-solid article comprises polyvinyl alcohol, polyacrylates and mixtures thereof.

21. The method according to claim 16 wherein the liquid comprises a solvent.

22. The method according to claim 21 wherein the solvent comprises a hydrophobic solvent.

23. The method according to claim 1 wherein the steps of contacting the soil present on the leather article with a soil removal facilitating agent and contacting the soil present on the leather article with a soil removal agent occur contemporaneously.

24. The method according to claim 1 wherein the step of contacting the soil present on the leather article with a soil removal facilitating agent occurs prior to the step of contacting the soil present on the leather article with a soil removal agent.

25. The method according to claim 1 wherein the step of contacting the soil present on the leather article with a soil removal facilitating agent occurs after the step of contacting the soil present on the leather article with a soil removal agent.

26. The method according to claim 1 wherein the step of contacting the soil present on the leather article with a soil removal facilitating agent occurs after a first step of contacting the soil present on the leather article with a soil removal agent, but before a second step of contacting the soil present on the leather article with a soil removal agent.
